(19) United States
(12) Patent Application Publication
(10) Pub. No.: US 2026/0113397 A1
(43) Pub. Date: Apr. 23, 2026

(54) METHOD FOR CONTROLLING COMMUNICATION PLAYBACK BETWEEN A HANDS-FREE SYSTEM IN A MOTOR VEHICLE AND A USER, AND A HANDS-FREE SYSTEM

(71) Applicant: MERCEDES-BENZ GROUP AG, Stuttgart (DE)

(72) Inventors: Jan BENDICK, Böblingen (DE); Alexander HANUSCHKIN, Karlsruhe (DE)

(21) Appl. No.: 19/166,984

(22) PCT Filed: Feb. 27, 2024
(86) PCT No.: PCT/EP2024/055014

§ 371 Date: Sep. 19, 2025

(30) Foreign Application Priority Data
Mar. 20, 2023 (DE) 10 2023 001 073.1

(51) Int. Cl. H04M 1/60; B60K 35/26; H04W 4/029; H04W 4/48

(52) U.S. Cl. CPC H04M 1/6091; B60K 35/26; H04W 4/029; H04W 4/48; B60K 2360/741; H04M 2201/40

(57) ABSTRACT

Communication playback between a hands-free system in a motor vehicle and a user is controlled by a control device electronically coupled to the hands-free system or at least one sound signal emitted from this at least one loudspeaker is at least partially modified. Parameters for determining a vehicle usage context are detected by a first detecting device electronically coupled to the hands-free system. Depending on the parameters of the vehicle usage context, a person in a vicinity of the motor vehicle is detected by a second detecting device electronically coupled to the hands-free system. A position of the person relative to the motor vehicle is detected, and depending on the detected position, a volume and/or a quality of speech intelligibility of the sound signal emitted from the loudspeaker is changed and directed at least partially to the position of the person by the control device.

### BACKGROUND AND SUMMARY OF THE INVENTION

Exemplary embodiments of the invention relate to a method for controlling communication playback between a hands-free system in a motor vehicle and a user, as well as to such a hands-free system.

A hands-free system in the motor vehicle makes it possible to have play back communication or have a conversation without using a mobile end device or a mobile phone. In particular, this is to prevent possible accident situations that could occur due to inattention from the driver while holding the mobile phone. In this case, measures to protect communication playback are provided, for example by using secure connections and by noise cancellation features and by positioning respective components of the hands-free system.

A motor vehicle audio system is disclosed in US 2015/0137998 A1, comprising an audio detector for detecting ambient noise outside of a vehicle and an audio processing module, in order to process the ambient noise and to identify an event outside of the vehicle therefrom. Depending on the event, a warning is provided to the occupants.

Another in-vehicle privacy system worth mentioning is disclosed in GB 2565518 A.

However, there is also the problem when using a hands-free system that the noise from the interior of the motor vehicle is not sufficiently cancelled in a vicinity of the motor vehicle to prevent third parties in an immediate vicinity of the motor vehicle from listening in.

Exemplary embodiments of the invention are directed to a method and a hands-free system, by means of which noise of the hands-free system from the interior of the motor vehicle is particularly efficiently cancelled in a vicinity of the motor vehicle.

A first aspect of the invention relates to a method for controlling communication playback between a hands-free system in a motor vehicle and a user, in which method at least one loudspeaker electronically coupled to the hands-free system, in particular a plurality of loudspeakers electronically coupled to the hands-free system, are controlled for communication playback by means of a control device electronically coupled to the hands-free system. It is provided here that respective sound signals emitted from the respective loudspeakers are changed for communication playback.

In order to solve the object of the invention, and thus provide the method by means of which noise of the hands-free system from the interior of the motor vehicle is particularly efficiently cancelled in a vicinity of the motor vehicle, the invention provides for carrying out a plurality of method steps that are described below.

In a first method step, detecting parameters for determining a vehicle usage context by means of at least one first detecting device electronically coupled to the hands-free system is provided for. Thus, for this purpose, during a telephone call via the hands-free system of the motor vehicle, the vehicle usage context, for example a journey on the motorway, waiting at a red light, parking in front of the outdoor pool, an open sunroof or side window, etc., is determined via the detecting device installed in the motor vehicle. For example, the speed and geoposition of the vehicle is also detected when the phone is answered or the call is made. If the vehicle is travelling at high speed in a sparsely populated area, it can be assumed that the telephone call cannot be overheard by a casual bystander, as they can only see and hear the vehicle for a short period of time. On the other hand, if a slow or stationary vehicle with an open sunroof is located near an open-air swimming pool or marketplace, it can be assumed that there are many casual bystanders who can listen in on the phone call over a long period of time.

In a second method step, depending on the parameters of the vehicle context, detecting a person in a vicinity, in particular in an immediate vicinity, of the motor vehicle by means of at least one second detecting device electronically coupled to the hands-free system is provided for. Thus, another potential eavesdropper context is determined in addition to the vehicle usage context. This eavesdropper context can be dependent in particular on the expected density of people at a specific place and in particular on the time, day of the week, weather, etc. This eavesdropper context can be determined from the second detecting device installed in the vehicle.

In a third method step, detecting a position of the person relative to the motor vehicle is provided for. Thus, along with the potential eavesdropper context, people and their positions in the immediate surroundings of the motor vehicle can be detected by means of the second detecting device.

In a fourth method step, depending on the detected position, changing a volume and/or a quality of speech intelligibility of the sound signal emitted from the at least one loudspeaker and directed at least partially to the position of the person by means of the control device is provided for. For example, the position of a person standing in the vicinity of the motor vehicle is detected by means of the second detecting device and position data is transmitted to the control device. The control device is now designed to control the respective loudspeakers, the sound signals of which are directed at least partially in the direction of the position, in such a way that these sound signals are at least partially reduced in their volume. The sound signals can be reduced by these measures such that essentially the person in the vicinity of the motor vehicle cannot eavesdrop the communication playback, since a directed noise reduction is carried out depending on the position of the person.

The sound quality and volume of the sound signal, which is to be created by the loudspeaker, is thus changed. A good speech intelligibility system should provide a clear, distinct and easily audible speech output, but in this case the intention is to change precisely this speech output depending on the position of the person so that this person can hear as little or as inaccurately as possible the speech output coming through the loudspeakers. For this purpose, the sound signals are at least partially changed in the direction of the person. In particular, specific areas in the interior of the motor vehicle can thus be filled with sound particularly strongly and other areas in the interior are particularly weakly filled with sound. The hands-free system thus has a space adjustment option by means of which the audio quality and the comfort is improved during a conversation and thus during the communication playback, in particular by adapting to the acoustic situations of the interior.

In an advantageous embodiment of the invention, it is provided that the first detecting device is provided as a visual detecting device and/or the second detecting device is provided as a visual detecting device. In particular, the first detecting device can thus be designed as an internal camera and the second detecting device as an external camera, whereby respective images from the interior and images from the surroundings are recorded and transmitted to the control device for analysis, wherein the control device is designed, for example, as an electronic computing device and analyzes the images by means of software or algorithms in order to detect the respective parameters or positions of the persons in the vicinity of the motor vehicle. The control device can perform further measures for sound reduction depending on the detected data and parameters. For example, an image of a person located on the path on the right next to the parked motor vehicle is recorded with an external camera of the vehicle. The image data is evaluated in the electronic computing device or in a control device of the motor vehicle and for example is assigned pixel-perfect to an object class using computer-assisted vision (CV) methods. Thus, it is possible to detect and to localize a person in the image.

In another advantageous embodiment of the invention, it is provided that the first detecting device is provided as a sensor device and/or the second detecting device is provided as a sensor device. For example, both detecting devices can be designed as microphones, ADAS signal receivers, sensor devices with movement sensors, which detect the position of windows and a sunroof, a speed of the vehicle and people in the vicinity.

In another further advantageous embodiment of the invention, it is provided that a trajectory is detected from a position change of a person in the vicinity of the motor vehicle by means of the second detecting device. In addition to the potential eavesdropping context, people in the direct vicinity of the vehicle can be detected by the second detecting device, which is designed, for example, as a sensor device with an external sensor system of the motor vehicle, in particular using other arranged components for more efficient detection of parameters and positions, for example by means of cameras, lidar, radar, ultrasound, etc. Thus, it is provided to detect the person and the trajectory from the position change and thus to determine the positions of the people in the in particular immediate vicinity of the motor vehicle relative to the vehicle orientation at each time point. Therefore, the control device can continually control the sound reduction depending on the moving person. With a visual detecting device as the second detecting device, it is possible to determine the movement of the person relative to the motor vehicle, i.e., relative to the camera orientation, which is fixed with respect to the vehicle orientation, from a sequence of chronological recordings/camera images.

Similarly, an embodiment of the invention has proved advantageous in which the control device is wirelessly coupled to a data center. Therefore, another potential eavesdropper context can be determined along with the vehicle usage context, wherein, for example, data is detected about an expected density of people at a determined place, as well as data, such as time, day of the week, weather, etc. This eavesdropper context can in this case be transmitted from a central data center via a wireless data communication device to the motor vehicle. For example, it can be therefore determined that the weather is good due to the sunshine and high temperatures and that it is a Sunday, thereby defining a particularly high volume of people, and requiring a particularly great noise reduction.

An embodiment of the invention has also proved to be advantageous in which another volume and/or another quality of speech intelligibility is detected in the vicinity of the motor vehicle by means of a third detecting device. In this case, the third detecting device is designed, for example, as an external microphone or has a plurality of external microphones. The external microphones on the motor vehicle can detect the sound radiating from the inside to the outside and the resulting sound pressure level and speech intelligibility can be recorded or determined by the scattering device or electronic computing device. For example, speech intelligibility can be measured with a subliminal STIPA test signal (Speech Transmission Index for Public Address Systems) by performing an amplitude modulation of noise in a frequency range of, for example, 125 Hz-10 kHz and concluding or quantifying a reduced speech intelligibility from a loss of modulation depth in the recorded external microphone signal.

Additionally, an embodiment of the invention has proved to be advantageous in which the sound signals are changed at least partially depending on the detected other volume and/or the detected other quality of speech intelligibility in the vicinity of the motor vehicle by means of the control device. In particular, the hands-free system can also be regulated. This regulation depends on different factors, such as for example the type of motor vehicle, the hands-free system and the personal configurations of the user. Although the control device as a volume controller and/or as a quality controller is thus controlled by the user via the steering wheel, for example, the third detecting device detects the volume and/or the quality of speech intelligibility to the outside and transmits at least one signal to the control device in order to at least partially reduce the volume and/or at least partially change the quality of speech intelligibility depending on the detected position or trajectory of a person in the vicinity. In particular, the frequency can also be controlled via an equalizer in such a way that the sound reaching the vicinity is at least partially reduced. For example, frequency bands can be selectively increased or reduced in frequency.

An embodiment of the invention in which individual users are detected by means of a fourth detecting device has proven to be equally advantageous. The individual users of the vehicle can be identified or recorded using a variety of methods, such as image recordings from a fourth detecting device designed as an interior camera. Other common methods include facial recognition using computer vision, personalized vehicle keys as the fourth detecting device, or a personal PIN code so that the recorded data of the user or of a passenger can be uniquely assigned to a person. Thus, physiological and driving-specific characteristic values/data in the vehicle can be detected via the fourth detecting device installed in the vehicle, processed and assigned to an individual person. For example, the possible changes in speech intelligibility can be made dependent on the user inside, with different frequencies being changed for a young user than for an older user.

Finally, in a further advantageous embodiment of the invention, it is provided that the sound signals are at least partially controlled by means of the control device depending on data of the detected individual user. By using information about the user, or driver or passenger, for example via the fourth detecting device designed as an interior sensor system, a user profile can be determined or extended in order to make a user-dependent change to the sound signal in order to protect privacy. For example, the age or the sound characteristics of the user can be queried from the user profile or approximately determined from the interior camera images and settings can be controlled to support the person.

A second aspect relates to a hands-free system for a motor vehicle with an electronically coupled control device for controlling communication playback between the hands-free system and a user, which control system is in turn designed to at least partially control a plurality of loudspeakers electronically coupled to the hands-free system and the respective volumes of the sound signals emitted from the respective loudspeakers for the communication playback. It is provided that parameters for determining a vehicle usage context can be detected by means of at least one first detecting device electronically coupled to the hands-free device, and a person in a vicinity of the motor vehicle and a position of the person relative to the motor vehicle can be detected by means of at least one second detecting device electronically coupled to the hands-free device and depending on the parameters of the vehicle context, and the volume of the sound signals emitted by the loudspeakers and at least partially directed to the position of the person can be reduced by means of the control device and depending on the position. For example, it is provided that the first detecting device is designed as a visual detecting device and/or the second detecting device is designed as a visual detecting device. Alternatively, it is provided that the first detecting device is designed as a sensor device and/or the second detecting device is designed as a sensor device. It is possible that a trajectory can be detected from a position change of a person in the vicinity of the motor vehicle by means of the second detecting device. It is also possible that the control device can be wirelessly coupled to a data center, in particular in order to detect environment data about the vicinity. By means of a third detecting device, a volume in the vicinity of the motor vehicle can be detected, whereby the sound signals can be at least partially controlled by means of the control device depending on the detected volume in the vicinity of the motor vehicle. An individual user can be detected by means of a fourth detecting device, whereby the sound signals can be at least partially controlled by means of the control device depending on the data of the detected individual user.

In other words, by means of the described method and by means of the described hands-free system in a vehicle, it is possible to prevent external eavesdropping on conversations conducted via the hands-free system in the vehicle, or at least to reduce the speech intelligibility outside the vehicle in such a way that eavesdropping on the conversation in the immediate vicinity of the vehicle is made significantly more difficult. The subject matter according to the invention thus allows the privacy of drivers and passengers to be increased and thus the feeling of luxury in the vehicle to be enhanced by digital means (‘digital luxury’).

Further advantages, features and details of the invention can be seen from the following description of preferred exemplary embodiments and from the drawings. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

Here:

FIG. 1 shows a first picture diagram to illustrate a first embodiment of a method for controlling communication playback between a hands-free system in a motor vehicle and a user using a data network;

FIG. 2 shows a second picture diagram to illustrate a second embodiment of the method, wherein a position or trajectory of a person is detected;

FIG. 3 shows a third picture diagram to illustrate a third embodiment of the method using microphones;

FIG. 4 shows a flow chart of a possible sequence of the method; and

FIG. 5 shows another flow chart of another possible sequence of the method.

In the figures, identical and functionally identical elements are provided with the same reference signs.

### DETAILED DESCRIPTION

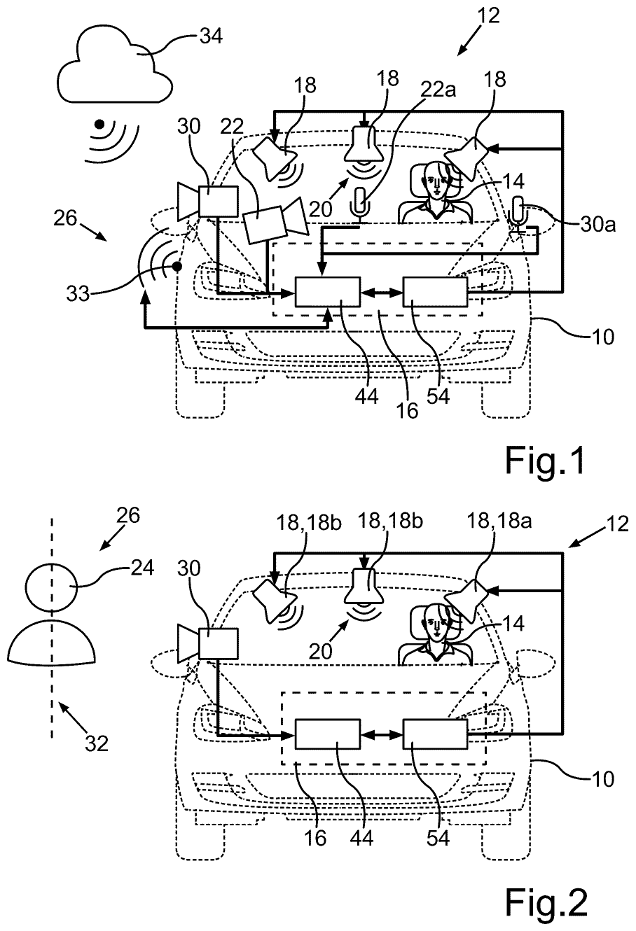

FIG. 1 shows a first picture diagram to illustrate a first embodiment of a method for controlling communication playback between a hands-free system 12 in a motor vehicle 10 and a user 14. In this case, it is provided that a plurality of loudspeakers 18 electronically coupled to the hands-free system 12 and the respective volume and/or quality of speech intelligibility of the sound signals 20 emitted from the respective loudspeakers 18 are at least partially controlled and/or changed by means of a control device 16 electronically coupled to the hands-free system 12.

In a first method step S1, detection of parameters for determining a vehicle usage context is provided for by means of at least one first detecting device 22 electronically coupled to the hands-free system 12. Thus, during use of the hands-free system 12 of the motor vehicle 10, the vehicle usage context is determined via the first detecting device 22 installed in the motor vehicle 10 and/or via a further, second detecting device 30 arranged on the motor vehicle 10. Also, parameters such as an open sunroof near an outdoor pool or marketplace or in the forest can be detected.

In a further, second method step S2, depending on the parameters of the vehicle usage context, detecting a person 24 in a vicinity 26, in particular in an immediate vicinity 26, of the motor vehicle 10 is provided for by means of at least one second detecting device 30 electronically coupled to the hands-free system 12. Thus, a potential eavesdropper context is also determined in addition to the vehicle usage context. This eavesdropper context can be dependent in particular on the expected density of people 24 at a specific place and in particular on the time, day of the week, weather, etc.

In a third method step S3, a position of the person 24 relative to the motor vehicle 10 is detected. Thus, along with the potential eavesdropper context, people 24 and their positions 32 in the vicinity 26 of the motor vehicle 10 can be detected by means of the second detecting device 30.

In a fourth method step S4, depending on the position 32, changing, in particular reducing, the volume and changing the quality of speech intelligibility of the sound signals 20 emitted from the loudspeakers 18 and at least partially directed to the position 32 of the person 24 is provided for by means of the control device 16. For example, the position 32 of a person 24 standing in the vicinity 26 of the motor vehicle 10 is detected by means of the second detecting device 30 and position data resulting therefrom is transmitted to the control device 16. The control device 16 is now designed to control the respective loudspeakers 18, the sound signals 20 of which are directed at least partially in the direction of the position 32, in such a way that these sound signals 20 are at least partially reduced in their volume and quality of speech intelligibility. The sound signals 20 can be changed by these measures such that essentially the person 24 in the vicinity 26 of the motor vehicle 10 cannot eavesdrop on the communication playback, since a directed noise change and/or noise reduction and/or quality change is carried out depending on the position 32 of the person 24 by means of the method.

In particular, a motor vehicle 10 is represented in FIG. 1, in which the first detecting device 22 is provided as a visual detecting device and/or the second detecting device 30 is provided as a visual detecting device, whereby camera images are detected by a user/driver 14 with the first detecting device 22 designed as an interior camera. Additionally, the vicinity 26 is detected by means of the second detecting device 30 that is designed as an external camera. The recordings are transmitted to the control device 16 for evaluation, wherein the control device can be designed as an electronic computing device or is electronically coupled with or has such an electronic computing device. The control device 16 thus detects the vehicle usage context and the potential eavesdropper context and recognizes people 24 in the direct vicinity 26 and their position 32 relative to the vehicle. In addition, the control device 16 receives information from internal microphones 22a and external microphones 30a in order to enable a possible control of the noise reduction and/or the quality change, which will be discussed in more detail in the following figures.

The control device 16 is wirelessly coupled to a data center 34. Therefore, a potential eavesdropper context can also be determined along with the vehicle usage context, wherein, for example, data is detected about an expected density of people 24 at a certain place. as well as data, such as time, day of the week, weather, etc. This eavesdropper context can be transmitted from a central data center 34 via a wireless data communication device 33 to the motor vehicle 10.

FIG. 2 shows a second picture diagram to illustrate a second embodiment of the method, wherein a position or trajectory of a person 24 is detected. Here, the position of a person 24 or the trajectory is detected from a position change of a person 24 in the vicinity 26 of the motor vehicle 10 by means of the second detecting device 30, in particular using other arranged components for more efficient detection of parameters and positions 32, for example by means of cameras, lidar, radar, ultrasound, etc. Thus, it is provided to detect the person 24 and the position or trajectory from the position change and thus to determine the positions 32 of the people in the in particular immediate vicinity 26 of the motor vehicle 10 relative to the vehicle orientation at each time point. Therefore, the control device 16 can continually control the change of sound depending on the stationary or moving person 24. With a visual detecting device as the second detecting device 30, it is possible to determine the movement of the person 24 relative to the motor vehicle 10, i.e., relative to the camera orientation, which is fixed with respect to the vehicle orientation, from a sequence of chronological recordings/camera images. In this case, shown in FIG. 2, the vehicle-side loudspeakers 18a are made louder than the other loudspeakers 18b which are located close to the person 24, in this case on the passenger side and in the center area of the motor vehicle 10.

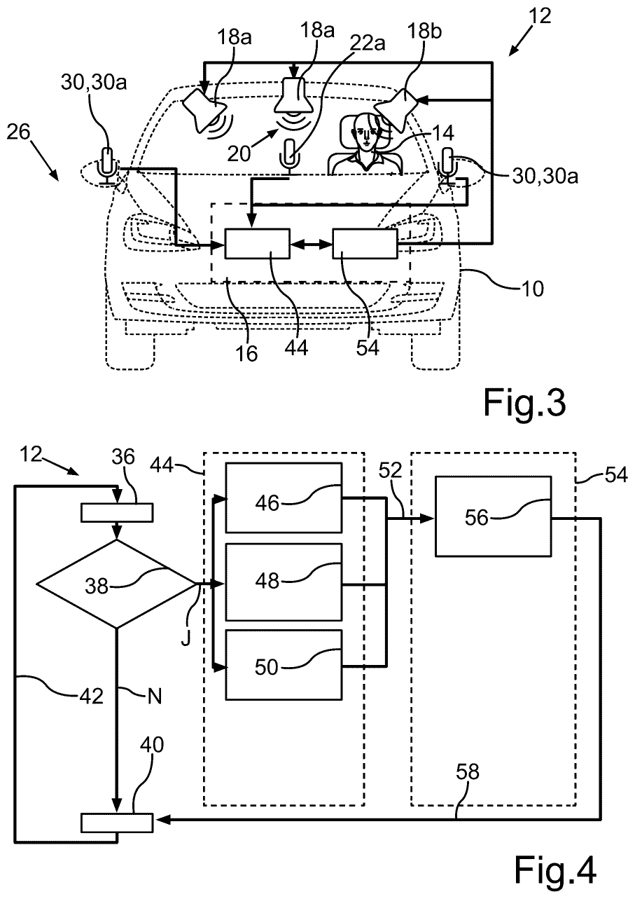

FIG. 3 shows a third picture diagram to illustrate a third embodiment of the method using microphones. In particular, the first detecting device 22 and/or the second detecting device 30 are provided as respective sensor devices, wherein the sensor devices have a respective microphone, for example. In particular, the control device 16 receives information from internal microphones 22a and external microphones 30a, in order to enable possible regulation of the noise reduction. Thus, a motor vehicle 10 is represented, in which the loudspeakers 18 play back voice messages or telephone calls, wherein the sound signals 20 are in turn received outside the motor vehicle by means of the external microphones 30a and are transmitted to the control device 16 for evaluation, whereby a control loop is also possible. The control device 16 can carry out a targeted noise reduction using recorded sound signals A that exceed a target value.

In particular, replayed voice messages or telephone calls are recorded by means of the interior loudspeakers 18 and analyzed by means of the control device 16 or a speech intelligibility is quantified. For example, the quality of an automatic transcript can be quantized when created, for example by statistics about the probability of the clear recognition of each individual word. This gives a value Q1 for the speech intelligibility quantized in the vehicle. Simultaneously, the speech intelligibility outside the vehicle Q2 is determined by means of the external microphones 30a. The values of Q1 and Q2 or values determined therefrom, such as for example the ratio of Q1 to Q2, is transmitted to the control device 16, which then changes the loudspeaker control, i.e., the created audio signal or the sound signals A, in such a way that the conversation content can be recognized best in the interior of the motor vehicle 10 and the least well outside of the motor vehicle, specifically in the vicinity 26, for example the quotient Q1/Q2 could be maximized for this purpose.

FIG. 4 shows a flow chart of a possible sequence of the method, which asks a first query 38 after a start 36, in which it is asked whether a conversation is to be played back via the loudspeakers 18 of the motor vehicle 10. In the event of a “no” N and thus rejection of the first query 38, the method is stopped via a stop command 40 and is provided for the restart 36 via a first loop 42. In the event of a “yes” Y and thus a confirmation of the first query 38, three exemplary commands 46, 48, 50 are executed in a first control device 44 designed in particular as an electronic computing device, wherein determining parameters depending on the vehicle usage context from data, which is detected by the first detecting device 22 designed, for example, as a sensor device, by means of the first command 46. A potential eavesdropper context is to be determined by means of a second command 48, in which the second detecting device 30 designed as an external sensor, for example, detects environmental parameters such as weather data. Similarly, the information can be received by the data center 34 wirelessly coupled to the first control device 44 and can be taken into account for the noise reduction and/or quality change. Now the people 24 are to be determined by means of a third command 50, in which for example, the second detecting device 30, designed for example as an external sensor, detects the position 32 of the person 24 in the vicinity 26 of the motor vehicle 10. The control device 44 designed as an electronic computing device can transmit a fourth command 52 to the second control device 54 by a combination of the data and/or information and/or parameters, in order to carry out a vehicle usage context-dependent control 56 of the loudspeakers 18. The sound signals 20 can be reduced by these measures such that essentially the person 24 in the vicinity 26 of the motor vehicle 10 cannot eavesdrop on the communication playback, since a directed noise reduction and/or quality change is carried out depending on the position 32 of the person 24. Subsequently, the method is then restarted at start 36 via a second loop 58.

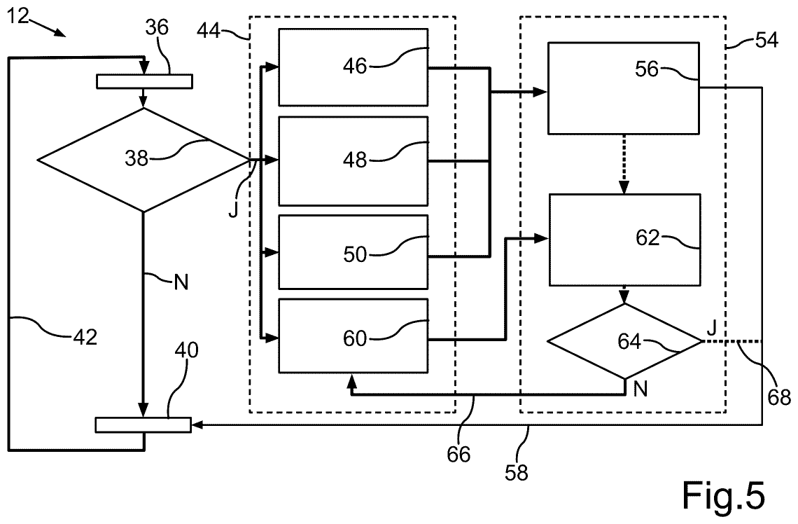

FIG. 5 shows another flow chart of another possible sequence of the method, wherein a further command 60 is provided in the first control device 44 designed as an electronic computing device, in which a quantization of speech content recognition as described in FIG. 3 is determined and wherein the data is detected by the respective detecting devices 14, 30 having internal and external microphones 22a, 30a. Thus, a further control 62 of the loudspeakers 18 is carried out by means of the second control device 54, in order to reduce the quality of the sound signals 20 towards the outside in the vicinity 26, as well as the volume and quality. In the motor vehicle 10, however, the quality of the sound signals 20 is to be maintained or improved. Subsequently, there is a further query 64 in which it is asked whether the conversation and thus the communication playback is to be ended.

In the event of a ‘no’ N and thus a rejection of the further query 64, the first control device 44, which is designed as an electronic computing device, is again instructed to collect data and/or information and/or parameters via a loop 66 in order to enable a renewed noise reduction in the vicinity 26, which can be repeated at a predetermined time interval. In the event of a “yes” Y and thus a confirmation of the further query 64, the method is then restarted at start 36 via a second loop 58.

In particular, for operating the method, the hands-free system 12 for the motor vehicle 10 is provided with the electronically coupled control device 16 for controlling communication playback between the hands-free system 12 and the user 14, which control device is in turn designed to at least partially control a plurality of loudspeakers 18 electronically coupled to the hands-free system 10 and the respective volumes of the sound signals 20 emitted from the respective loudspeakers 18 for the communication playback. In this case, parameters for determining a vehicle usage context can be detected by means of at least the first detecting device 22 electronically coupled to the hands-free system 12, and the person 24 in the vicinity 26 of the motor vehicle 10 can be detected, as can the position 32 of the person 24 relative to the motor vehicle 10, by means of at least the second detecting device 30 electronically coupled to the hands-free system 12 and depending on the parameters of the vehicle usage context. Also, by means of the control device 16 and depending on the position 32, the volume of the sound signals 20 emitted by the loudspeakers 18 and at least partially directed to the position 32 of the person 24 can be reduced in such a way that a noise reduction in the vicinity 26 is made possible.

Again, in other words, in FIGS. 1 to 5, in particular three technical implementations for preventing or at least for reducing the speech intelligibility outside the motor vehicle 10 are described, which can make it significantly more difficult to eavesdrop on a conversation of a user 14 or which can be designed individually or in combination.

In this case, in a first implementation, the telephone call via the hands-free system 12 can be played back in a context-dependent manner by means of a sound system installed in the motor vehicle 10 in such a way that the privacy of the user 14 is increased, particularly without reducing the quality of the voice playback. For this purpose, the loudspeakers 18 are controlled during the voice playback in a context-dependent manner, as represented in FIG. 2 and in the flow chart of FIG. 4.

Thus, for example, the left loudspeaker 18 can take over the playback when a person 24 is located to the right of the motor vehicle 10. If the person 24 moves from back right to front left, the control of the loudspeaker 18 can be adjusted gradually and according to the trajectory of the person 24 from the front left to the back right in the motor vehicle 10. This effect can be increased by the use of special 3D audio playback formats. Furthermore, the volume of the sound signal 20 or of the audio signal and the resulting noise emission are temporarily reduced when the person 24 stops directly next to the motor vehicle 10.

In a second implementation, the frequency-dependent sound insulation characteristics of the motor vehicle 10, which can differ generally between motor vehicle types and equipment features, are used in order to reduce quality of the voice signal in the vicinity 26 of the motor vehicle 10 by “pitch-shifting” (simultaneously changing all frequencies) or “pitch correction” (different frequency-dependent changes) of the sound signal 20 or the audio signal or by the alternative or additional use of an equalizer (combination of high and low-pass filters) for filtering the sound signal 20 or the audio signal.

In particular, there is a competition between two different counteracting effects when raising the low frequencies of the sound signal 20 or the audio signal. On the one hand, it is possible to utilize the fact that higher frequencies are generally dampened to a greater degree by the interior of the vehicle 10 than low frequencies, so that a uniform increase in these frequencies can lead to an increase in relative sound insulation. On the other hand, however, depending on the sound characteristics of the sound signal 20 or the speech signal, low resonant frequencies can occur, which are usually perceived subtly and much louder after the frequency raise. The frequency-raised lower resonant frequencies would therefore increase the perceived speech intelligibility outside the motor vehicle 10 in a particularly disadvantageous manner.

In the case of corresponding sound characteristics without low resonance frequencies of the sound signal 20 or the speech signal, the low frequencies of the sound signal 20 or of the audio signal can thus be raised for a younger user 14, which actively improves the sound insulation of the motor vehicle 10 without significantly reducing the perceived speech intelligibility. In addition, it can be recognized from the user profiles via a worn hearing aid or on the basis of audiometry performed in the motor vehicle 10 that it is only possible to raise low frequencies in a certain frequency range without excessively reducing speech intelligibility by the user.

Optionally, to improve speech intelligibility, the change and/or distortion of the sound characteristics, for example in the case of dialects, accents, etc., can be compensated for by special codecs that can pitch and modify the speech in such a way that the original sound characteristics are retained or additionally harmonized.

Alternatively, if only the low frequencies of the sound signal 20 or the audio signal are lowered, speech intelligibility inside the motor vehicle 10 is only slightly reduced, as the high-frequency audio signal components can be easily perceived, while it is precisely these high-frequency sound signal components or audio signal components that are dampened by the sound insulation of the motor vehicle 10 in the immediate vicinity 26 of the motor vehicle 10.

A control strategy for ‘pitch shifting’ or ‘pitch correction’ is accordingly dependent on the frequency-dependent sound insulation characteristics of the motor vehicle 10, which vary relative to the sound system in the vehicle interior and measurement position relative to the motor vehicle 10, as well as on the sound characteristics of the reproduced speech signal of a telephone call. The frequency-and direction-dependent sound insulation characteristics can be measured acoustically during the development of the motor vehicle 10 and the sound characteristics can be determined from the speech signal in real time using digital audio signal processing.

In a third implementation, by using the external microphones 30a on the motor vehicle 10, the sound signals 20 or the audio signals can be modified in such a way that the sound signals 20 or the audio signals, especially speech, are perceived with the best possible speech intelligibility in the interior of the motor vehicle and with reduced speech intelligibility in the vicinity 26 of the motor vehicle 10. For this purpose, subliminal STIPA test signals or natural language processing (NLP) methods can be used to automatically convert speech content into text, for example.

If no test signal is used, a general quality difference dG of speech intelligibility between the interior and the vicinity 26 of the motor vehicle 10 can be determined by measuring/averaging/quantifying the quality of speech intelligibility in the interior GI and in the exterior GA and determining the ratio, in particular a quotient of the two values dG=GA/GI.

If the same method for determining the quality of speech intelligibility is applied to the sound signals 20 or audio signals played back in the motor vehicle 10 and the sound signals 20 or audio signals recorded in the vicinity 26 of the motor vehicle 10 or from the audio information recorded simultaneously by internal and external microphones 22a, 30a, the respective qualities of speech intelligibility can be determined/quantified and compared.

For example, the quality of speech intelligibility can be determined from an automatic transcription of the conversation using NLP methods. This means that the speech playback in the motor vehicle 10 can be improved in such a way that the transcription is at its worst in the vicinity and at its best in the interior, or that a weighting between the two extremes is achieved. For example, the intelligibility of the conversation in the interior GI could be weighted more heavily than the poor intelligibility in the vicinity GA, e.g., dG=GA/GI\hat{ }alpha, or similar.

The quality of an automatic transcript can be quantified, by for example compiling statistics about the probabilities of the clear recognition of each individual word. This gives a value GI for the speech intelligibility quantified in the interior of the motor vehicle 10. Simultaneously, the speech intelligibility outside the motor vehicle 10 GA is determined by means of external microphones 30a. The values of GI and GA or values determined therefrom, such as for example the ratio of GI to GA, is transmitted to the control device 16, which then changes the loudspeaker control, i.e., the created sound signal 20 or the audio signal, in such a way that the conversation content can be recognized best in the interior of the motor vehicle 10 and the least well in the vicinity 26 of the motor vehicle 10; for example, for this, the quotient GA/GI could be minimized using the optimization methods known from the prior art, as represented in FIG. 3.

A motor vehicle 10 can also generally be any vehicle on land, on water or in the air. The motor vehicle 10 can therefore be a (road) motor vehicle 10, such as a passenger car or a heavy goods vehicle or a bus, but also an aircraft, a watercraft, an emergency vehicle 10, a construction machine, an agricultural or a military vehicle 10. In particular, it can also be a rail-bound vehicle, such as a train, suspension railway, magnetic levitation train or a capsule gliding on air cushions in a largely airless tube or hovering due to magnetic forces.

The user 14 can be any person in the motor vehicle 10, for example the driver, the passenger or other persons in a means of transport intended for the carriage of passengers.

Furthermore, the automatic improvement of the sound signal 20 or the audio signal described above can also depend on the context of use of the motor vehicle and the eavesdropper context, as well as recognized persons 24 in the vicinity 26 of the motor vehicle 10. For this purpose, several microphones located at different locations outside the motor vehicle 10 are used in order to reduce the quality of the recognition of the conversation content by changing the audio signals for the external microphones 30a closest to the persons 24, as shown in the flow chart in FIG. 5.

Furthermore, a comparatively valuable luxury vehicle is parked at a red traffic light and the driver of the comparatively valuable luxury vehicle is conducting a business conversation, which may in particular contain confidential or secret information. The current motor vehicle usage context (stationary motor vehicle 10) and the potential eavesdropping context (urban area with high population density) determine an increased need to modify the playback of the telephone call using the sound system installed in the motor vehicle 10 so that the privacy of the user 14 is protected in the best possible way. For this purpose, the low frequencies of the sound signal 20 or the audio signal are lowered first. As the user 14 of the motor vehicle 10 is recognized as being relatively young on the basis of the stored user profile and/or interior camera images, which were evaluated using computer-assisted vision methods, their speech intelligibility inside the motor vehicle 10 is only slightly reduced or not reduced at all, as the high-frequency audio signal components can still be easily perceived by the user 14.

In addition, by comparing the internal and external speech intelligibility, which is carried out based on internal and external microphone recordings and a quantification of the speech intelligibility quality, the properties of the playback of the audio signal are optimized in such a way that the sound signals 20 or the audio signals, especially speech, are perceived with the best possible speech intelligibility in the vehicle interior and with reduced speech intelligibility in the vicinity of the vehicle 10. The optimum playback parameters may, for example, depend on the sound characteristics of the user 14 and the other person involved in the phone call. If a person 24 now steps next to the motor vehicle 10, this is recognized by the motor vehicle sensors and the position of the motor vehicle 10 and its trajectory relative thereto are also determined. Based on this information, the loudspeakers 18 in the interior can be controlled in such a way that the sound signal 20 emitted in the direction of this person 24 is further reduced.

In other words, the invention describes a context-dependent control of communication playback in a vehicle to protect privacy.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for controlling communication playback between a hands-free system in a motor vehicle and a user, wherein at least one loudspeaker electronically coupled to the hands-free system is controlled for communication playback by a control device electronically coupled to the hands-free system or at least one sound signal emitted from the at least one loudspeaker is at least partially modified, the method comprising:
detecting, by at least one first detecting device electronically coupled to the hands-free system, parameters for determining a vehicle usage context;
detecting, by at least one second detecting device electronically coupled to the hands-free system, a person in a vicinity of the motor vehicle; and
detecting a position of the person relative to the motor vehicle,
wherein the person is detected in the vicinity of the motor vehicle depending on the parameters of the vehicle usage context during a phone call via the hands-free system and depending on the detected position of the person, a volume or a quality of speech intelligibility of the sound signal emitted from the at least one loudspeaker and directed at least partially to the position of the person is changed by the control device.

12. The method of claim 11, wherein the at least one first detecting device is a visual detecting device or the at least one second detecting device is a visual detecting device.

13. The method of claim 11, wherein the at least one first detecting device is a sensor device or the at least one second detecting device is a sensor device.

14. The method of claim 11, wherein a trajectory is detected from a position change of the person in the vicinity of the motor vehicle by the second detecting device.

15. The method of claim 11, wherein the control device is wirelessly coupled to a data center.

16. The method of claim 11, wherein another volume or another quality of speech intelligibility is detected in the vicinity of the motor vehicle by a third detecting device.

17. The method of claim 16, wherein the sound signals are changed at least partially depending on the detected another volume or the detected another quality of speech intelligibility in the vicinity of the motor vehicle by the control device.

18. The method of claim 16, wherein individual users are detected by a fourth detecting device.

19. The method of claim 18, wherein the sound signals are at least partially controlled depending on data of the detected individual users by the control device.

20. A hands-free system for a motor vehicle, the hands-free system comprising:
an electronically coupled control device configured to control communication playback between the hands-free system and a user, wherein the electronically coupled control device is configured to at least partially control a plurality of loudspeakers electronically coupled to the hands-free system and respective volumes of sound signals emitted from the respective loudspeakers, wherein parameters for determining a vehicle usage context are detected by at least one first detecting device electronically coupled to the hands-free system and a person in a vicinity of the motor vehicle and a position of the person relative to the motor vehicle are detected by at least one second detecting device electronically coupled to the hands-free system,
wherein, during a phone call using the hands-free system, the person in the vicinity of the motor vehicle is detected by the second detecting device and depending on the parameters of the vehicle usage context, a volume of the sound signals emitted from the plurality of loudspeakers and at least partially directed to the position of the person is reduced depending on the position of the person.
